(19) United States
(12) Patent Application Publication
(10) Pub. No.: US 2008/0182527 A1
(43) Pub. Date: Jul. 31, 2008

(54) Information Processing Apparatus

(75) Inventor: Masanori Nakano, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/016,413

(22) Filed: Jan. 18, 2008

(30) Foreign Application Priority Data
Jan. 31, 2007 (JP) 2007-022177

(51) Int. Cl. H04B 1/38

(52) U.S. Cl. 455/90.3

(57) ABSTRACT

An information processing apparatus includes: an antenna for wireless communication; a wireless communication module to which a signal received from the antenna is input and which outputs a transmission signal to the antenna; a cable connecting the antenna and the wireless communication module to transmit the received signal and the transmission signal are transmitted between the antenna and the wireless communication module; a control unit that controls the wireless communication module; a first housing that houses the antenna, the wireless communication module, and the cable; and a second housing that supports the first housing and houses the control unit.

### CROSS-REFERENCE TO RELATED APPLICATIONS

This application is based upon and claims the benefit of priority from Japanese Patent Application No. 2007-022177, filed on Jan. 31, 2007, the entire content of which are incorporated herein by reference.

### BACKGROUND

1. Field

One embodiment of the invention relates to an information processing apparatus having a wireless communication unit capable of suppressing deterioration of a received signal.

2. Description of the Related Art

Conventionally, there is proposed an information processing apparatus that is improved with antenna sensitivity by providing a notched portion in a part of a metal housing and arranging an antenna in the notched portion. An example of such configuration is disclosed in JP-A-2002-032150 (counterpart U.S. publication numbers are: U.S. Pat. No. 6,804,110 B2 and U.S. Pat. No. 7,009,568 B2).

The information processing apparatus includes a display unit including an LCD panel, a metal housing that covers a back surface of the display unit, and an antenna arranged at a notched portion provided in an upper portion of the metal housing. In this information processing apparatus, a radio wave that the antenna receives and transmits is not blocked by the metal housing because the notched portion is provided. Accordingly, satisfactory antenna sensitivity can be achieved.

However, in the conventional information processing apparatus, the antenna sensitivity is satisfactory but loss of a gain of a signal received by the antenna occurs within a cable through which the received signal is transmitted until the received signal is input to a wireless communication module, which performs processing for the signal, provided in the information processing apparatus, or a noise is superimposed on a signal. For this reason, there is a problem that a signal may deteriorate.

### SUMMARY

According to a first aspect of the present invention, there is provided an information processing apparatus including: an antenna for wireless communication; a wireless communication module to which a signal received from the antenna is input and which outputs a transmission signal to the antenna; a cable connecting the antenna and the wireless communication module to transmit the received signal and the transmission signal are transmitted between the antenna and the wireless communication module; a control unit that controls the wireless communication module; a first housing that houses the antenna, the wireless communication module, and the cable; and a second housing that supports the first housing and houses the control unit.

According to a second aspect of the present invention, there is provided an information processing apparatus including: an antenna for wireless communication; a wireless communication module to which a signal received from the antenna is input and which outputs a transmission signal to the antenna; a control unit that controls the wireless communication module; a first housing that houses the antenna and the wireless communication module; and a second housing that supports the first housing and houses the control unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating an information processing apparatus according to a first embodiment of the invention.

FIG. 2 is a perspective view illustrating the inside of the information processing apparatus according to the first embodiment of the invention.

FIG. 3 is a block diagram illustrating the configuration of the information processing apparatus according to the first embodiment of the invention.

FIG. 4 is a perspective view illustrating the inside of the information processing apparatus according to the second embodiment of the invention.

### DETAILED DESCRIPTION

Hereinafter, information processing apparatuses according to embodiments of the invention will be described in detail with reference to the accompanying drawings.

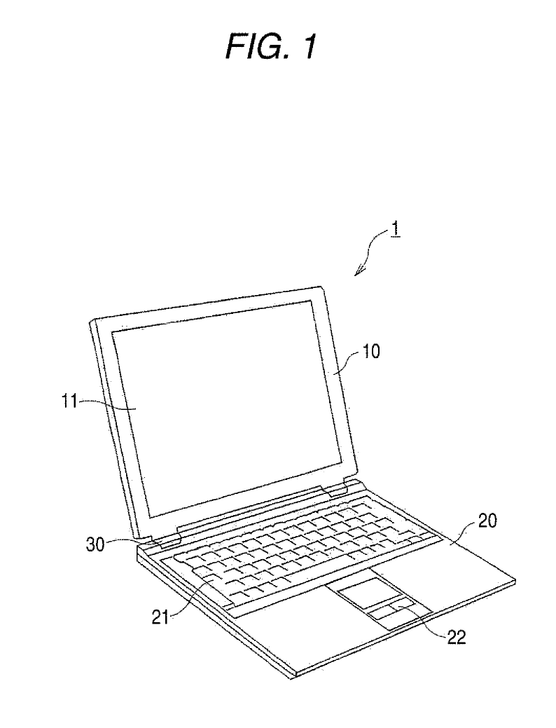

FIG. 1 is a perspective view illustrating an information processing apparatus according to a first embodiment of the invention.

An information processing apparatus 1 is configured to include an upper housing 10 and a lower housing 20, and the upper housing 10 and the lower housing 20 are openably and closably connected by a hinge portion 30. The upper housing 10 is provided with a display unit 11 that displays characters and images. The lower housing 20 is configured to include electronic components, such as a CPU (central processing unit) and an HDD (hard disc drive), and has a character input unit 21 used to input a character or a command and an operation unit 22 serving as a pointing device.

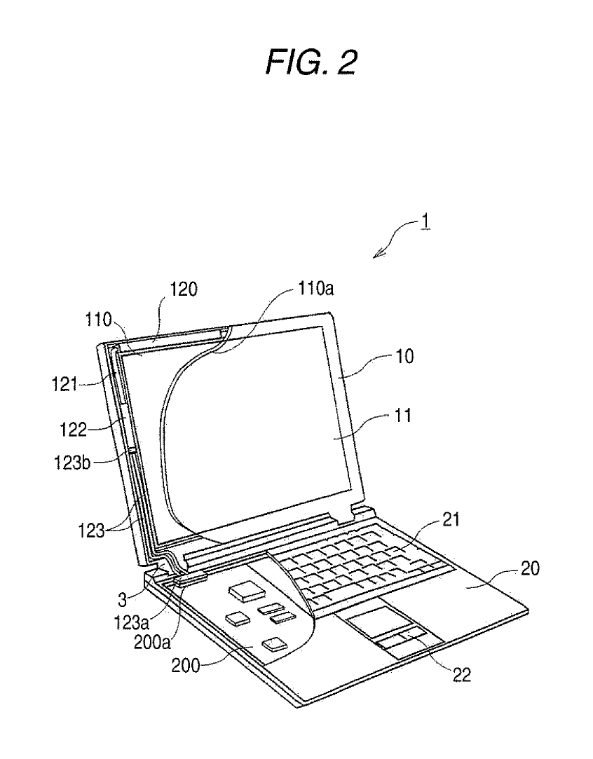

FIG. 2 is a perspective view illustrating the inside of the information processing apparatus according to the first embodiment of the invention.

The upper housing 10 has an antenna 120 that transmits and receives a radio wave, an RF (radio frequency) cable 121 through which a signal received by the antenna 120 is transmitted, and a wireless communication module 122 that demodulates the signal and performs processing for the signal. The upper housing 10 has the display unit 11, and the display unit 11 is provided with an LCD (liquid crystal display) 110, a backlight (not shown), and an inverter for a backlight (not shown). The lower housing 20 has a main substrate 200, which is a mother board on which a CPU and the like are mounted, and is connected with the wireless communication module 122 through a connection harness 123.

The antenna 120 receives a radio wave based on a CDMA system, for example, and has a length of 15 cm. For example, the RF cable 121 is a coaxial cable, and the RF cable 121 having a diameter of 1.13 mm is used. The length of the RF cable 121 is assumed to be 20 cm or less.

The connection harness 123 has a plurality of cables, for example, five or more cables, has a connector 123a and a connector 123b at both ends thereof, and is connected with a wireless communication module and a connector 200a on the main substrate 200. In addition, the connection harness 123 is arranged from the upper housing 10 to the lower housing 20 through the hinge portion 30.

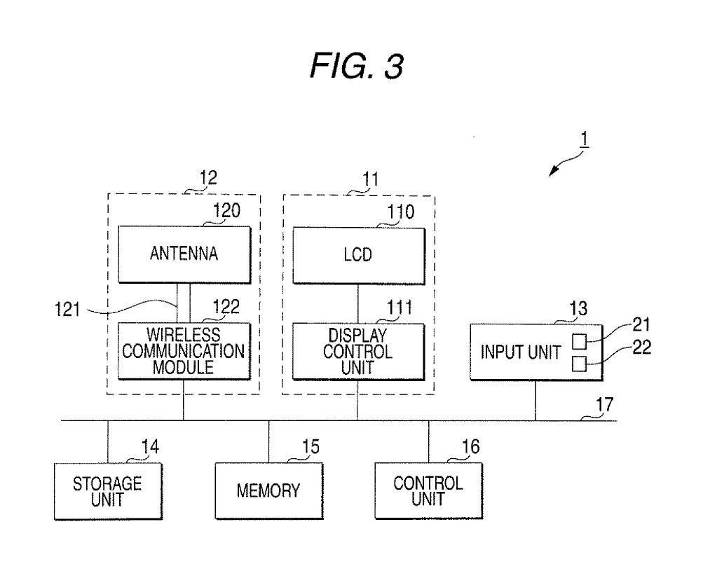

FIG. 3 is a block diagram illustrating the configuration of the information processing apparatus according to the first embodiment.

The information processing apparatus 1 includes: the display unit 11 configured to include the LCD 110, which displays a character or an image, and a display control unit 111 which performs a control related to display of the LCD 110; a communication unit 12 configured to include antenna 120 which transmits and receives a radio wave, an RF cable 121 through which the received signal is transmitted, and the wireless communication module 122 which demodulates the signal and performs processing for the signal; an input unit 13 that is able to operate the information processing apparatus 1 and includes the character input unit 21 and the operation unit 22 shown in FIG. 1; a storage unit 14 that stores information as magnetic information, a memory 15 which temporarily stores information at the time of information processing; a control unit 16 that makes an overall control on each unit of the information processing apparatus 1 so as to operate the information processing apparatus 1; and a bus 17 which connects the units with each other.

Hereinafter, an operation of the information processing apparatus according to the first embodiment will be described with reference to the accompanying drawings.

Input operation of the information processing apparatus 1 is performed in the input unit 13, and processing is executed in the control unit 16 in accordance with the command input through the input unit 13. When processing is executed in the control unit 16, the memory 15 assists the processing by temporarily storing data therein. A display signal is input to the display control unit 111 to be processed. The LCD 110 and a backlight (not shown) receive an output signal of the display control unit 111 and display an image. Information required to be stored is transmitted to the storage unit 14, and the storage unit 14 stores the information as magnetic information.

The antenna 120 receives a radio wave for communication based on a CDMA system from an external device, the received radio wave is transmitted as a signal through the REF cable 121, and the signal is demodulated by the wireless communication module 122. An output of the wireless communication module 122 is input to the control unit 16, such that predetermined processing is executed. In addition, when a signal is transmitted to the outside, a signal modulated by the wireless communication module 122 is transmitted through the RF cable 121 and is then transmitted from the antenna 120.

When a signal that the antenna 120 outputs after receiving a radio wave from external device is transmitted through the RF cable 121, loss of a gain occurs in proportion to the length of the RF cable 121. For example, in the present embodiment, loss of a gain is about 1 dB when the length of the RF cable 121 is 50 cm. If the length of the RF cable 121 is 20 cm, loss of a gain is about 0.3 Db.

The sensitivity of the antenna 120 is −5 dBi, for example, and the intensity of a signal which can be received by the wireless communication module 122 is −110 dB. However, in the case of W-CDMA standard of the CDMA system, the information processing apparatus 1 needs to enable carrier authentication even in the situation in which the intensity of a radio wave is −100 dBm. If loss of a gain in the RE cable 121 having a length of 50 cm is 1 dB, the carrier authentication of the information processing apparatus 1 is greatly affected. Accordingly, it is preferable to set the length of the RE cable 121 to 20 cm or less.

The RF cable 121 receives various kinds of noises in proportion to the length thereof.

According to the first embodiment described above, since the wireless communication module 122 is provided inside the upper housing 10 in which the antenna 120 is provided, a distance between the antenna 120 and the wireless communication module 122 is decreased compared with a known case in which the wireless communication module 122 is provided in the lower housing 20. As a result, since the RF cable 121 can be shortened, loss of a gain of a signal occurring in the RF cable 121 and noises generated in the RF cable 121 can be suppressed.

In addition, the radio wave that the antenna 120 receives is not limited to the radio wave based on a CDMA system. Moreover, the shape of the antenna 120 does not matter as long as the antenna 120 can be provided in the information processing apparatus 1.

Hereinafter, a configuration of an information processing apparatus according to a second embodiment will be described with reference to the accompanying drawings. Furthermore, in the following description, parts having the same configurations and functions as those in the first embodiment are denoted by the same reference numerals.

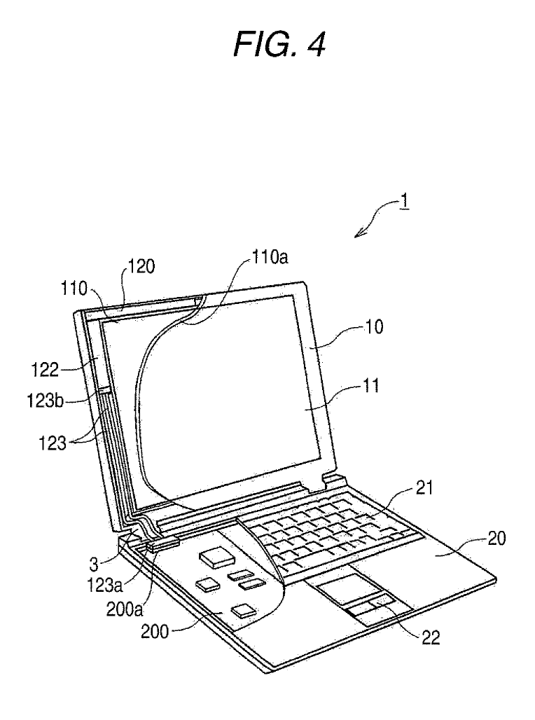

FIG. 4 is a perspective view illustrating the inside of the information processing apparatus according to the second embodiment of the invention.

An upper housing 10 includes an antenna 120 which transmits and receives a radio wave and a wireless communication module 122 which demodulates the signal received by the antenna 120 and performs processing for the signal.

The wireless communication module 122 for Bluetooth has a size of 13.8×29.0×5.0 mm, for example. Terminals of the antenna 120 and the wireless communication module 122 are electrically connected to each other, and accordingly, an RF cable is not used.

The antenna 120 receives a radio wave for communication based on the Bluetooth from external device, the received radio wave is directly input as a signal to the wireless communication module 122, and the input signal is demodulated by the wireless communication module 122. An output of the wireless communication module 122 is input to the control unit 16, such that predetermined processing is executed. In addition, when a signal is transmitted to the outside, a signal modulated by the wireless communication module 122 is input to the antenna 120 and a radio wave is transmitted from the antenna 120b.

According to the second embodiment, the antenna 120 and the wireless communication module 122 are connected to each other without using an RF cable compared with the first embodiment. Accordingly, the loss of a gain and noises, which have been caused by REF in the related art, can be suppressed.

As described above with reference to the embodiments, there is provided an information processing apparatus that is improved with suppressing a deterioration of a received signal.

The present invention is not limited to the embodiments described above, but the invention may be embodied in practice by modifying constituent components without departing the scope of the claimed invention. Various kinds of inventions may be realized by proper combination of the plurality of constituent components disclosed in the embodiment described above. For example, some constituent components may be eliminated from all the components shown in the above embodiments. Moreover, constituent components in different embodiments may be appropriately combined.

What is claimed is:

1. An information processing apparatus comprising:
an antenna for wireless communication;
a wireless communication module to which a signal received from the antenna is input and which outputs a transmission signal to the antenna;
a cable connecting the antenna and the wireless communication module to transmit the received signal and the transmission signal are transmitted between the antenna and the wireless communication module;
a control unit that controls the wireless communication module;
a first housing that houses the antenna, the wireless communication module, and the cable; and
a second housing that supports the first housing and houses the control unit.

2. The information processing apparatus according to claim 1, wherein the total length of the cable is 20 cm or less.

3. The information processing apparatus according to claim 1, wherein the wireless communication module is connected to the control unit through a harness and transmits and receives a signal.

4. An information processing apparatus comprising:
an antenna for wireless communication;
a wireless communication module to which a signal received from the antenna is input and which outputs a transmission signal to the antenna;
a control unit that controls the wireless communication module;
a first housing that houses the antenna and the wireless communication module; and
a second housing that supports the first housing and houses the control unit.

5. The information processing apparatus according to claim 4, wherein the antenna is directly connected to the wireless communication module and is used for communication of the received signal and the transmission signal.

6. The information processing apparatus according to claim 4, wherein the wireless communication module is connected to the control unit inside the second housing through a harness and transmits and receives a signal.
